(19) United States
(12) Patent Application Publication
(10) Pub. No.: US 2007/0162333 A1
(43) Pub. Date: Jul. 12, 2007

(54) Method of verifying a claim in an online pay for performance business model

(76) Inventor: John H. Helm, San Francisco, CA (US)

Correspondence Address: MORGAN, LEWIS & BOCKIUS, LLP., 2 PALO ALTO SQUARE, 3000 EL CAMINO REAL, PALO ALTO, CA, 94306, US

(21) Appl. No.: 11/332,717

(22) Filed: Jan. 12, 2006

(51) Int. Cl. G06Q 30/00

(52) U.S. Cl. 705/14

(57) ABSTRACT

A host identifies a user at a client computer and transmits listings of property or goods or services to the client computer for display to the user. The host logs the transmitted listings and the dates of the transmissions. A claim from the user that he has entered into a transaction corresponding to one of those listings is received. The claim is validated if the user entered into the transaction after the corresponding listing was transmitted for display to the user. In response to the validation, provision of a reward to the user is facilitated.

### RELATED APPLICATIONS

This application is related to U.S. patent application Ser. No. ______ titled “Method of Providing Variable Rewards in an Online Pay for Performance Business Model,” filed Jan. 12, 2006, Attorney Docket number 064625-5002-US, which is hereby incorporated by reference herein in its entirety.

### TECHNICAL FIELD

The disclosed embodiments relate generally to real estate listing services, and more particularly, to methods and systems for validating a claim that a user viewed an online real estate listing prior to entering into a purchase or lease for the unit corresponding to that listing.

### BACKGROUND

In recent years, the Internet has become a key element in the marketing strategies of many industries. One industry that is adapting to marketing on the Internet is the real estate industry. Several internet listing services (“ILS”) have emerged over the years to serve the needs of the real estate industry. One service these ILS's provide is apartment locating services, where property owners and/or managers post units available for rent on an ILS website and potential renters search through the ILS for units that interest them.

Some of these ILS's that provide apartment rental listings use a pay for performance business model. In this model, a property owner/manager posts rental units on the ILS and pays the ILS a referral fee when a lease for a unit posted on the ILS is consummated. Additionally, the renter of a unit posted on the ILS may be given a reward (which may be monetary or in-kind) for using the ILS in finding the rented unit. This model not only provides the ILS monetization opportunities for its service (through the referral fees), it also provides opportunities for collection of data regarding the effectiveness of the ILS in referring potential renters to property owners/managers.

However, a challenge with this model is the problem of ensuring that the renter actually found the unit for which the lease was entered into through the ILS, rather than through other means such as printed advertisements, reconnoitering of the neighborhood, word of mouth, or other websites. Validation of claims by renters that they entered into leases for units found via the ILS is important because the property owner/manager may be unwilling to pay the referral fee if the ILS was not the source of the referral, thus reducing the revenues of the ILS.

### SUMMARY

According to some embodiments, a method of validating a claim for a reward includes identifying at a host computer a user associated with a client computer; transmitting from the host computer to the client computer one or more listings for display to the user; for each of the one or more listings transmitted, logging at the host computer the respective listing and a date the respective listing was transmitted for display to the user; receiving a claim that the user has entered into a transaction corresponding to a particular listing of the listings logged at the host computer; validating the claim if the particular listing was transmitted for display to the user prior to the user entering into the transaction; and based on the validating, facilitating provision of a reward to the user.

According to some embodiments, the aforementioned methods may be performed by a system that includes one or more processors and memory that includes instructions to perform the aforementioned operations.

According to some embodiments, instructions for performing the aforementioned methods may be included in a computer program product.

### BRIEF DESCRIPTION OF THE DRAWINGS

FIG. 1 is a block diagram illustrating a computer network, in accordance with some embodiments;

FIG. 2 is a block diagram illustrating a server system, in accordance with some embodiments;

FIG. 3 is a block diagram illustrating a client system, in accordance with some embodiments;

FIG. 4 is a flow diagram of a process for registering with a host that transmits listings, in accordance with some embodiments;

FIG. 5 is a flow diagram of a process for submitting listings to a host and setting reward attributes for the listings, in accordance with some embodiments;

FIG. 6 is a flow diagram of a process for transmitting listings for display to a user, in accordance with some embodiments; and

FIGS. 7A and 7B are flow diagrams of a process for validating a claim by a user that he had obtained a listing provided by the host before entering into a transaction corresponding to that listing, in accordance with some embodiments.

FIGS. 8A-8F are diagrams illustrating correspondences between different locations, unit types or date ranges and rewards or the lack thereof.

Like reference numerals refer to corresponding parts throughout the drawings.

### DETAILED DESCRIPTION OF EMBODIMENTS

A host may provide a service where providers (such as sellers, service providers, lessors, or the like) may provide listings of property (real estate or goods) for sale or lease or listings of services. Users interested in patronizing such may search the listings. A user may enter into a transaction corresponding to one of these listings and be rewarded for finding the listing via the service provided by the host and entering into the transaction afterwards. To be rewarded, the user submits a claim that he entered into a transaction corresponding to a listing found via the service, and the host validates the claim if the listing was transmitted for display to the user prior to the user entering into the transaction. Also, the reward may be one of one or more rewards provided by a provider. The reward that is provided may vary based on criteria set by the provider.

As used herein, the listings of real estate or goods for sale or lease or listings of services are hereinafter referred to as “listings.” A person or entity (or a representative, agent, or contractor of the person or entity) who submits a listing to a host for presentation to and consideration by users is referred to as a “provider.” A person or entity (or a representative, agent, or contractor of the person or entity) who is interested in entering into particular types of transactions, such as buying or leasing goods or real estate or buying services, and wishes to be displayed listings for such transactions from providers is referred to as a “user.”

In some embodiments, the users are interested in transactions such as purchases or leases of units of real estate, and the providers have units of real estate to sell or lease. Thus, the term “user” may include potential buyers or renters of real estate and the term “provider” may include owners or managers of property, or their representatives, agents, or contractors. The listings are units of real estate that the providers wish to sell or lease, and the transactions are sales or leases of such units. The “units” may include residential or commercial buildings or individual units within such.

It should be appreciated that real estate unit listings is merely one example of the listings that may be submitted by providers for presentation to users. Other types of listings may be possible. For example, providers may provide listings of goods for sale or lease for consideration by users who are potential buyers or renters of these goods. Similarly, the providers may provide listings of services for consideration by users who are potential patrons of these services.

For ease of understanding, the description below will describe the disclosed embodiments in the context of real estate units for lease. However, it should be appreciated that the disclosed embodiments may be applicable to contexts other than real estate units for lease, such as real estate units for sale, goods, or services.

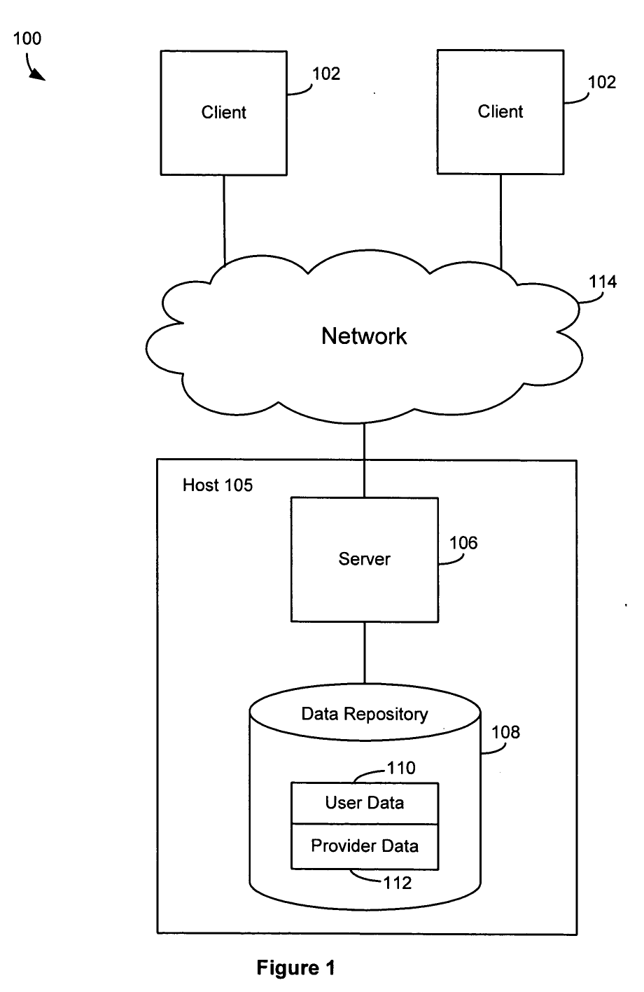

FIG. 1 is a block diagram illustrating a computer network in accordance with some embodiments. The computer network 100 includes one or more clients 102, a host 105, and a network 114 that facilitate communication between the aforementioned components. The network 114 may include a local area network (LAN), wide area network (WAN), intranets, wireless networks, the Internet, or the like.

The clients 102 are computing devices from which users and providers of listings may interact with the host 105. The clients 102 may include, without limitation, a personal computer (PC), workstation, notebook computer, personal digital assistant (PDAs), mobile phone, or any other device capable of accessing the host via the network 114. In some embodiments, the clients 102 may include a web browser or some other application that provides an interface between the user or provider and the host 105.

The host 105 receives listings submitted by providers and transmits them to clients 102 for display to users. The host 105 includes a server 106 and a data repository 108. The server 106 acts as a front end interface for the host 105, such as through a firewall. The server 106, among other things, transmits documents (such as webpages) and data from the data repository 108 to clients 102 for display. In some embodiments, the server 106 provides a web-based interface, through which users and providers of listings interact via a client application, such as a web browser. In some embodiments, the host 105 is owned and/or operated by a third party person or entity that is distinct from the users or the providers. In some other embodiments, a provider may also be the operator or owner of the host 105. For ease of description, both the host 105 and the owner/operator thereof is referred to as the “host.”

The host 105 also includes the data repository 108. The data repository stores user data 110 and provider data 112. The user data 110 includes users' login information, identification information, and logs identifying listings that have been transmitted to clients 102 for display to users and the dates when the listings were transmitted. The provider data 112 includes providers' login information, identification information, listings provided by the providers, attributes of rewards that may be provided to users, and criteria for providing such rewards. In some embodiments, the data repository 108 may be a relational database. In some other embodiments, the data repository 108 may be a database using an alternative data model or some other form of electronic record-keeping. Further details regarding login information, identification information, listings, and rewards are described below.

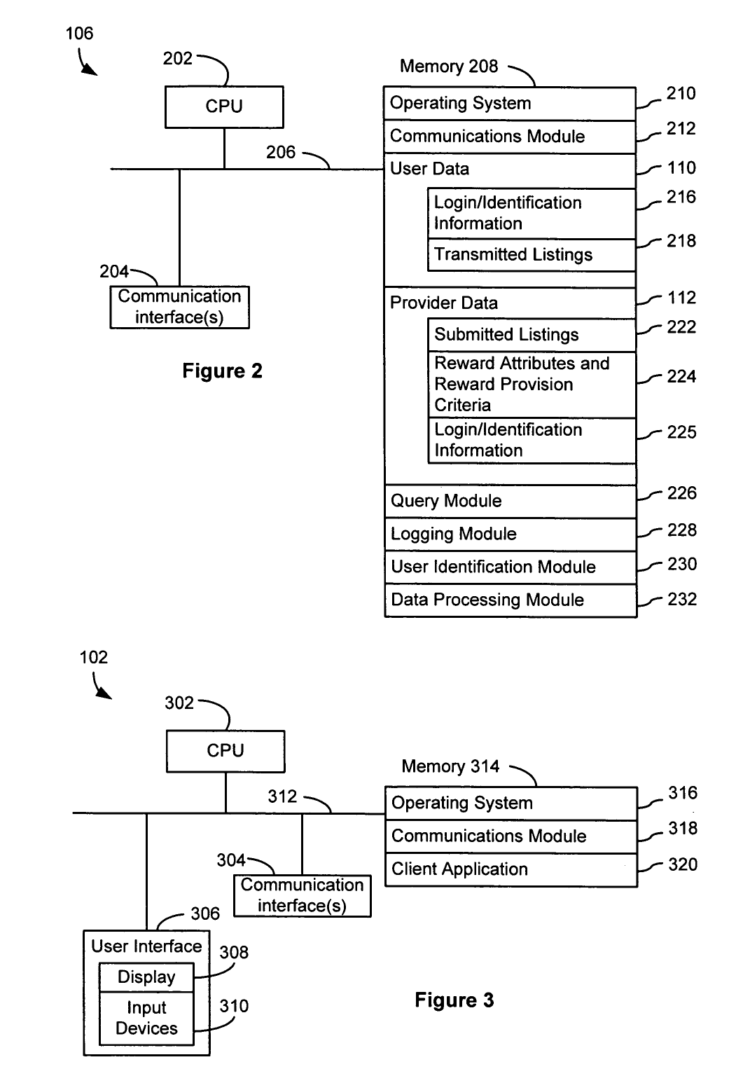

FIG. 2 is a block diagram illustrating a server system, in accordance with some embodiments. The server system 106 generally includes one or more processing units (CPU's) 202, one or more network or other communications interfaces 204, memory 208, and one or more communication buses 206 for coupling these components. The server system 106 may optionally include a user interface, such as a display, a keyboard, and a mouse (not shown). The memory 208 includes random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 208 may optionally include one or more storage devices remotely located from the CPU(s) 202. In some embodiments, the memory 208 stores the following programs, modules and data structures, or a subset thereof:
an operating system 210 that includes procedures for handling various basic system services and for performing hardware dependent tasks;
a communications module 212 that is used for connecting the server 106 to other computers via the one or more communication network interfaces 206 (wired or wireless), such as the Internet, other wide area networks, local area networks, metropolitan area networks, and so on;
user data 110, which includes data associated with users;
provider data 112, which includes data associated with providers;
a query module 226, for receiving and processing searches for listings by users;
a logging module 228, for logging listings displayed to users;
a user identification module 230, for identifying users and providers via a registration and a login/logout procedure; and
a data processing module 232 for receiving and processing data received from users and providers, including receiving claims from users for rewards and processing and validating such claims, facilitating provision of rewards, storing data in the user data 110 and the provider data 112, and sending data to clients 102 for display to users or providers.

The user data 110 include login/identification information 216 and transmitted listings 218. The user login/identification information 216 includes information for identifying a user interfacing with the server system 106, such as login information and contact information. The transmitted listing (or transmitted listings log) 218 identifies listings that were transmitted for display to users and the dates (and optionally time) of the transmissions. In other words, the transmitted listings 218 are a log of the listings that are transmitted for display to users. The user to which a listing is transmitted for display is identified as well. In some embodiments, there are per-user records of transmitted listings in the transmitted listings 218. In some other embodiments, all of the transmitted listings are logged in a common transmitted listings log 218 but the log 218 includes a field identifying the user to which a listing is transmitted.

The provider data 112 include login/identification information 225, submitted listings 222, and reward attributes and reward provision criteria 224. The provider login/identification information 225 includes information for identifying a provider interfacing with the server, such as login information and contact information. The submitted listings 222 are listings submitted by providers to the server system 106, so that they may be transmitted for display to users, for consideration by those users. In some embodiments, each listing submitted by a provider is assigned a unique identifier. The reward attributes and reward provision criteria 224 specify the reward(s) a user may receive if he enters into a transaction corresponding to a listing that was transmitted for displayed to the user, and the reward provision criteria specify the rules or criteria for determining which reward is to be provided to a user whose claim is validated.

In some embodiments, the server system 106 may store listing data separately from the user data 110 and provider data 112. The listing data may include records of the submitted listings 222. Each record of a submitted listing may include some identification of the provider who submitted the listing to the host and include a log of users to whom the listing was transmitted for display and the dates (and optionally the times) of those transmissions.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 208 may store a subset of the modules and data structures identified above. Furthermore, memory 208 may store additional modules and data structures not described above.

Although FIG. 2 shows a “server system,” FIG. 2 is intended more as functional description of the various features which may be present in a set of servers than as a structural schematic of the embodiments described herein. In practice, and as recognized by those of ordinary skill in the art, items shown separately could be combined and some items could be separated. For example, some items shown separately in FIG. 2 could be implemented on single servers and single items could be implemented by one or more servers. The actual number of servers used to implement a server system and how features are allocated among them will vary from one implementation to another, and may depend in part on the amount of data traffic that the system must handle during peak usage periods as well as during average usage periods.

FIG. 3 is a block diagram illustrating a client system, in accordance with some embodiments. The client system 102 typically includes one or more processing units (CPU's) 302, one or more network or other communications interfaces 304, memory 314, and one or more communication buses 312 for interconnecting these components. The client system 102 may also include a user interface 306 comprising a display device 308, such as a monitor, and one or more input devices 310, such as a keyboard or a mouse. The memory 314 includes random access memory, such as DRAM, SRAM, DDR RAM or other random access solid state memory devices; and may include non-volatile memory, such as one or more magnetic disk storage devices, optical disk storage devices, flash memory devices, or other non-volatile solid state storage devices. Memory 314 may optionally include one or more storage devices remotely located from the CPU(s) 302. In some embodiments, the memory 314 stores the following programs, modules and data structures, or a subset thereof:
an operating system 316 that includes procedures for handling various basic system services and for performing hardware dependent tasks;
a network communication module 318 that is used for connecting the client system 102 to other computers via the one or more communication network interfaces 304 (wired or wireless), such as the Internet, other wide area networks, local area networks, metropolitan area networks, and so on;
a client application 320 for interfacing with the server system 106.

A user of the client system 102 may interface with the server system 600 via the client application 320. In some embodiments, the client application 320 may be a web browser, and a user or provider interfaces with the server system 106 via a web-based interface. In some other embodiments, the client application 320 may be a custom application configured specifically to provider user/provider interface with the server system 106.

In some embodiments, one or more cookies (not shown) may be stored in the memory 314. The cookies may hold the login information and perhaps session information for a user or a provider whenever the user or provider is interfacing with the server system 102.

Each of the above identified elements may be stored in one or more of the previously mentioned memory devices, and corresponds to a set of instructions for performing a function described above. The above identified modules or programs (i.e., sets of instructions) need not be implemented as separate software programs, procedures or modules, and thus various subsets of these modules may be combined or otherwise re-arranged in various embodiments. In some embodiments, memory 314 may store a subset of the modules and data structures identified above. Furthermore, memory 314 may store additional modules and data structures not described above.

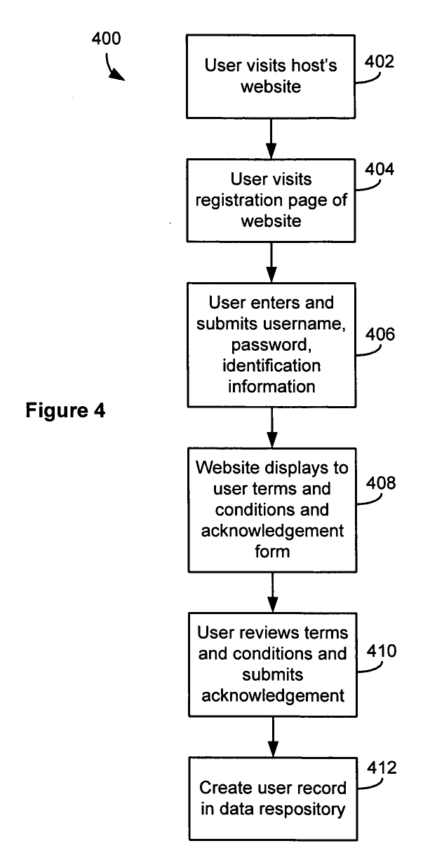

FIG. 4 illustrates a process flow 400 of a process for registering with a host that provides listings, such as listings of rental units, in accordance with some embodiments. A user seeking to rent real estate visits a website of a host that provides rental unit listings (402). The user, from a client 102, may access the website via a web browser or some other client application. In some embodiments, the website may permit access to its listings of rental units only to registered users. Thus, if the user is not already registered, the user visits the registration page of the host website (404). At the registration page, the user provides and submits information, such as a username and password for logging into the website and other identification information, such as name, phone number, address, email address, and so forth (406). The provision and submission of the information may be done in one page or spread out over several pages, and the amount and nature of the information obtained may vary in any given embodiment based on the needs of the user, the provider, and/or the host.

After the submission of the login and identifying information, in some embodiments, the user may be displayed terms and conditions regarding usage by the user of the host's listings service (408). The user is also provided a manner of acknowledging the terms and conditions, perhaps as a condition of completion of registration. In some embodiments, that manner of acknowledgement may be a button in the webpage labeled as “I agree to these terms,” “I accept these terms,” or the like. In some other embodiments, the user may need to click a radio button or a checkbox next to text such as “I agree to these terms,” “I accept these terms,” or the like, and then click a button labeled “Next,” “Finish,” or the like. The user reviews the terms and conditions and acknowledges them in the manner provided, and optionally performs any additional steps toward completion of registration, completing the registration process (410).

It should be appreciated, however, that provision of information by the user and acknowledgement of terms and conditions are merely exemplary steps in an online registration process and their order and manner of occurrence as described above are also merely exemplary. As known to one of ordinary skill in the art, online registration may include additional steps in addition to, or in lieu of, the steps described above, and the steps may be in a different order than described above.

Once the user has completed registration, a record associated with the user may be created in the host data repository (412). The record stores the information provided by the user at the time of registration. The record may also store, as the user makes use of the host website over time, log(s) identifying rental unit listings that the host website has transmitted for display to the user. The logs include the listings transmitted or the identifiers thereof, the date (which may include all dates the listing was transmitted or only the earliest and latest dates) the listing was transmitted to the user, and optionally the time on the date when the listing was transmitted. Additionally, in some embodiments, the user, upon completion of registration, is logged into the website and the user may begin using the website to search for rental units.

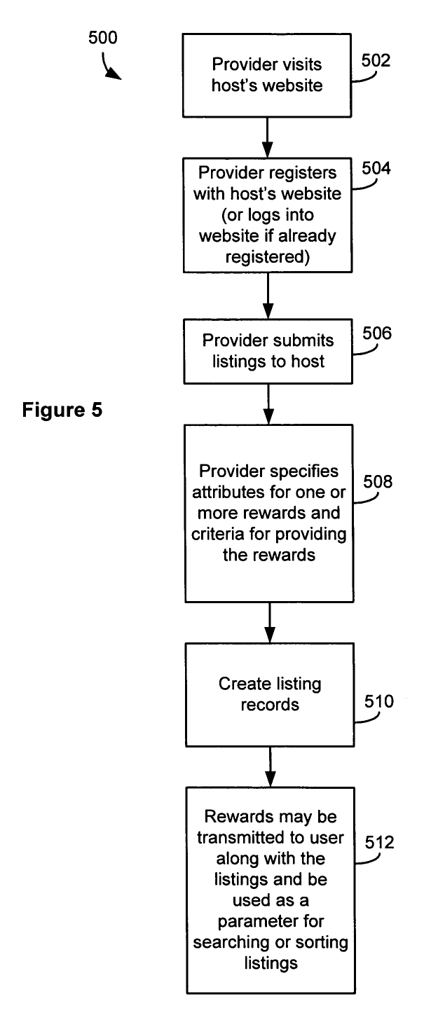

FIG. 5 illustrates a process flow 500 of a process for submitting listings to a host and setting reward attributes associated with the listings, in accordance with some embodiments. Providers of real estate rental unit listings, such as property owners or managers or their representatives, agents, or contractors (hereinafter “property owner” for convenience) may submit listings of their rental units to the host website. The users of the host website may search for rental unit listings by providing specified parameters.

A property owner visits the host website (502). The property owner may visit the host website via a client application on a client 102. The property owner registers with the website, if he is not already registered (504). If the property owner is already registered, the property owner may simply login to the website. The registration process for property owners is similar to that for users described above: the property owner provides login information such as a username and password, and perhaps other identification information such as name, company, address, phone number, or email address. In some embodiments, the property owner may also be displayed terms and conditions regarding usage of the host website by the property owner and the property owner may be required to acknowledge the terms and conditions before registration is completed. After registration, a record may be created for the property owner in the provider data. The record includes, among other things, login information and identification information for the property owner. Once logged in, the property owner may submit listings of rental units to the website (506). A listing of a rental unit may include an address of the unit, one or more pictures of the unit and the property at which the unit is located, a description of the unit and its features, and optionally other pertinent information, such as a link to an online map showing the location of the property at which the unit is located.

The host may employ a pay for performance business model. In such a business model, the property owners submit rental unit listings to the host, and the listings are transmitted to users of the host for display. When a user of the host enters into a lease for a unit submitted by the property owner to the host, the host is paid a referral fee.

The user may also be rewarded for finding the unit for which he entered into the lease via the host. The reward may be in the form of a monetary payment to the user, a discount on the rent for a specified duration, or an in-kind reward (e.g., a gift certificate, a good or a service, frequent flyer miles, discounts at stores, and so forth). In some embodiments, the reward is a specified absolute amount. In some other embodiments, the reward may be a specified percentage of the rent as agreed to in the lease. Furthermore, in some embodiments, the reward may be determined in real-time based on a specified formula or on specified criteria.

In some embodiments, along with the property listings, the property owner may also submit attributes for one or more rewards that may be provided to users who enter into leases for units submitted by the property owner to the host website, along with specified criteria or rules for providing the rewards to such users (508). As described below, the reward that may be provided to such user may vary based on criteria or rules, specified by the property owner, for providing the rewards. The criteria may include criteria for varying the reward that is provided to the user based on whether the user accessed the listings via a promotional campaign, and criteria for varying the reward based on date of the transaction, location of the unit, or type of unit. In other words, the criteria or rules associate a reward with a respective listing. In some embodiments, the possible location or type criteria include:
portfolio: the reward is the same across all of the property owner's units submitted to the host;
regional: the reward may vary by the geographic location or region in which the rental unit is located; the geographic location or region may be any identifiable geographic division, such as one or more states, one or more counties, one or more cities, towns, and/or municipalities, or one or more neighborhoods within a city, town, and/or municipality;
property: the reward may vary by the property, which may be a single building or a complex comprising a plurality of buildings, in which the rental unit is located; units in one property are associated with one reward and units in another property is associated with another reward;
floor plan: the reward may vary by floor plan type (e.g., a 1 bedroom unit vs. a 2 bedroom unit); and
unit: the reward may vary for each unit at a property.

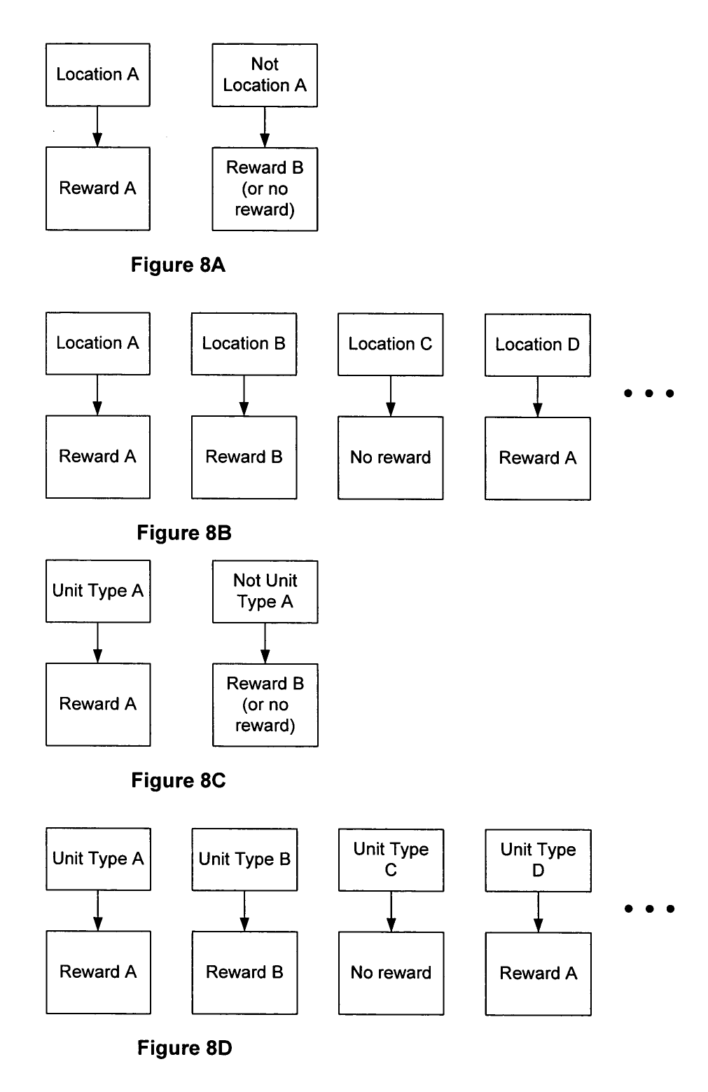

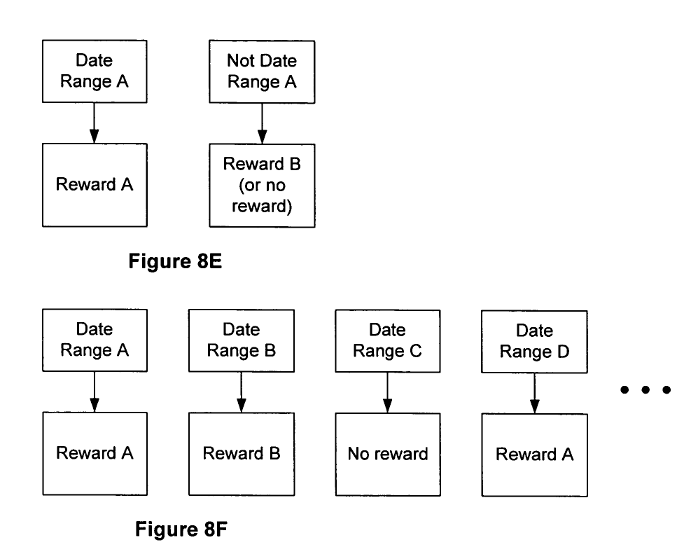

In some embodiments, the user may get one reward for entering into a lease for a unit that is located in a particular location (e.g., geographical region or property) or for a unit of a particular unit type (e.g., floor plan) and get a different reward (or nothing) for entering into a lease for unit located somewhere else or for a unit of a different type. In some embodiments, multiple locations or unit types may be specified and different rewards (or no reward) may be given depending on the location or unit type of the unit for which the lease was entered into. Examples of these location/unit type to reward correspondences are illustrated in FIGS. 8A-8D.

In some embodiments, the reward may also vary by time or date interval, in addition to or in lieu of varying by region, property, floor plan, etc. In some embodiments, the reward may be higher for units viewed or leased during specified time periods, examples of which may include a particular time period within the year or particular months of the year. For example, the user may get one reward for entering into a lease during June, July, or August, and get a different reward (or possibly no reward) for entering into a lease during a month other than June, July and August. In some embodiments, multiple date ranges may be specified and different rewards (or no reward) may be given depending on the date range during which the lease was entered into. Examples of these date range to reward correspondences are illustrated in FIGS. 8E-8F. Furthermore, in some embodiments, the reward may vary based on the time elapsed relative to the moment a listing was presented to the user. In other words, the reward the user may receive may vary based on how quickly the user acts in entering into a lease for a rental unit after viewing a listing for the rental unit.

In some other embodiments, the reward may vary based on the number or percentage of units available or already leased. Furthermore, the reward may vary based on whether or not the reward is advertised directly to users via, for example, a promotional campaign. Thus, for example, a user who visits the host from a link in an email advertisement and views the property owner's listings may be eligible for one reward, while another user who stumbles onto the host website and views the same listings may be eligible for a different reward.

It should be appreciated that the ways in which the reward may vary, as described above, are merely exemplary. Any combination of the ways described above and any additional ways not described above may be adopted.

After the property owner submits the unit listings, the reward attributes, and the reward provision criteria, records of unit listings may be created (510). A record of a unit listing includes the listing along with information about the unit, the identity of the property owner that submitted the listing, and the associated reward. In some embodiments, the listing and the record thereof may be assigned a unique identifier. The reward may be transmitted along with a listing with which it is associated (512). Users may also search for units with the reward as a search parameter. For example, a user may search for units that include a discount on the rent of 5% or more for a year upon consummation of the lease. As another example, a user may search for units that include provision of frequent flyer miles upon consummation of the lease. The rewards may also be communicated to users in promotional campaigns.

In some embodiments, the listing information may be entered into the host by a third party, including an employee, representative, agent, or contractor of the host, pursuant to written or oral instructions from the property owner.

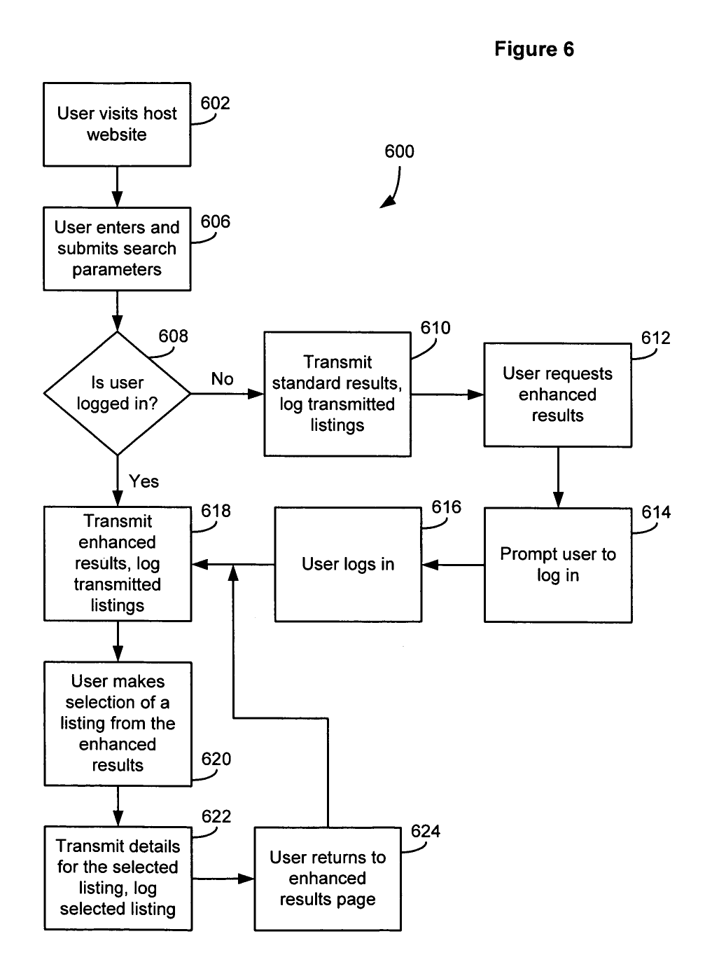

FIG. 6 illustrates a process flow 600 of a process for transmitting listings for display to a user, in accordance with some embodiments. A user visits the host website (602). The host website provides a page in which the user may enter a search query for listings of rental units. The search query includes specified values for one or more parameters on which the user wishes to search. The parameter(s) for which the user may specify values for the search query may include, among other things, the location, amount of rent, the reward, the number of bedrooms, available amenities, and so forth. The user enters and submits the search query (606).

If the user is not logged in (608—no), the host transmits to the client 102, for display to the user a standard results page, which includes rental unit listings that match the user's search query and basic information about them (610). In some embodiments, the standard results may include only a subset of the listings that match the search query. The basic information may include, in some embodiments, limited location information and the amount of rent for the displayed unit listings. The host logs the listings that are included in the transmitted standard results, and the date (and optionally the time) the listings are transmitted. In some embodiments, the host records in the logs an identifier of the listing transmitted and the date of the transmission. If the user is already registered and logged in (608—yes), then the host transmits for display to the user enhanced results (618), which includes the listings and information included in the standard results plus additional information about the listings. In some embodiments, the enhanced results includes the whole set of listings that match the search query. In some embodiments, the additional information may include a number of rooms at a unit and a brief listing of amenities. The host logs the listings (or the identifiers thereof) that are transmitted to the user and the date (and optionally the time). In some embodiments, the user logs in when the user browses to the host website at block 602. In some embodiments, a user can specify that the host may store login information at the user client (e.g., in a cookie) and whenever the user visits the host website, the host may read the stored login information and automatically log in the user.

From the standard results page, the user may request the enhanced results (612). At that point, the host may prompt the user to login as a registered user in order to gain access to the enhanced results (614). The user logs in (or registers and then logs in) (616). The host transmits for display to the user the enhanced results (618). The listings transmitted (or the identifiers thereof) are logged, along with the dates of the transmission.

In some embodiments, the standard or enhanced results may span more than one page. In other words, the set of listings may be displayed in a plurality of pages. A listing is not transmitted to the user client 102, and thus not logged, until the page on which the listing is to be displayed is actually requested by the user for display and is transmitted for display.

The user may, from the enhanced results page, request additional details for a particular listing by selecting the listing for which he wishes to see additional information (620). The host transmits for display to the user detailed information for the listing selected by the user (622). The host also logs the selected listing (or the identifier thereof) and the date that the detailed information for the listing was transmitted to the user. From there, the user may return to the enhanced results page (624), at which point the host transmits for display to the user the enhanced results page (618).

In some embodiments, the user may also request detailed information for a listing by selecting the listing from the standard results page. If the host limits access to detailed information for a unit to registered users, the host may prompt the user to log in as a registered user before transmitting to the user the detailed information.

In some embodiments, the rewards associated with the listings may be displayed along with the listings. In some embodiments, in the standard or enhanced results pages, the listings may be sorted based on the reward, as well as other parameters, such as amount of rent, location, etc.

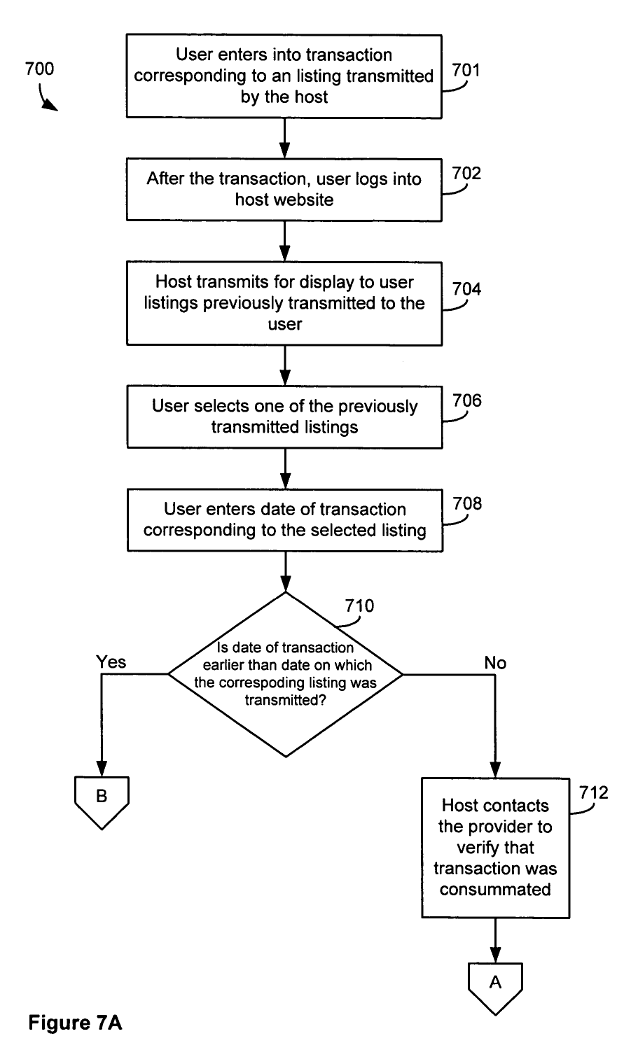

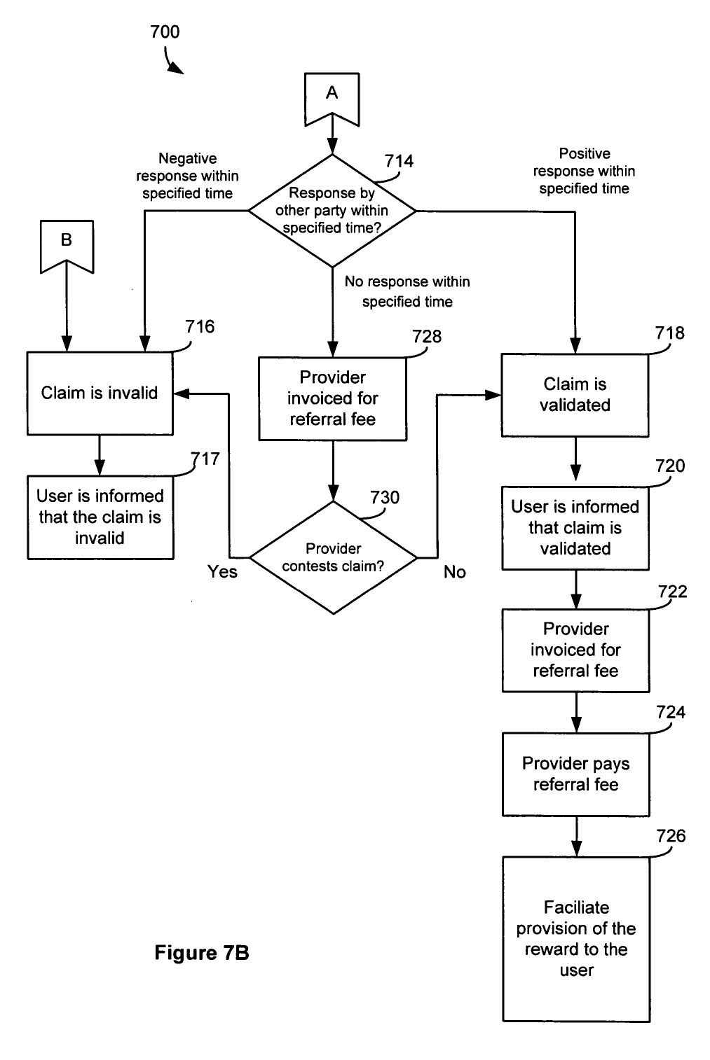

FIGS. 7A and 7B illustrate a process flow 700 of a process for validating a claim by a user that he had obtained a listing from the host before entering into a transaction corresponding to that listing, in accordance with some embodiments. When the user is displayed the detailed information for a rental unit, the user is provided the contact information of the property owner of the unit or a way to contact the property owner. For example, in some embodiments, instead of providing the property owner's contact information, the host may provide the user an online form that the user may use to compose a message to the property owner. The user may contact the property owner and proceed with the rental process, which may culminate in a lease for the unit specified in the listing being entered into by the user and the property owner (701). At that point, the user may revisit and login to the host website (702). The host transmits to the client 102 for display to the user the listings (or the identifiers thereof) that the host had transmitted before for display to the user, when the user had previously visited the website and searched for rental unit listings (704). In some embodiments, the host may transmit only the listings that were transmitted before for display to the user in a specified time period, e.g., within the last 6 months or the last year. The host identifies the previously transmitted listings via the logs of the listings transmitted and their dates, as described in relation to FIG. 6 above.

The user makes a claim that he has entered into a lease for a unit found via the host website, and thus is entitled to the reward associated with the listing for the unit. The user makes the claim by selecting, from the listings transmitted for display in block 704, the rental unit listing for which he wishes to make the claim (706). The user also provides a date at which he entered into the lease for that selected unit (708). If the date of the lease provided by the user is earlier than the earliest logged date on which the corresponding listing was transmitted for display to the user (710—yes), then the claim is invalid (716). The user may be informed that the claim is invalid (717), as described below. In some embodiments, the date of lease provided by the user is compared instead to the earliest date the corresponding listing was transmitted for display to the user within a specified time period. The claim is invalid if the date of the lease is earlier than that earliest date. If the claim is invalid, the user gets no reward and the property owner is not obligated to pay the corresponding referral fee.

By transmitting to the user the listings that were previously transmitted to the user and forcing the user to select from the set of previously transmitted listings for submission of his claim, the host narrows the field of listings from which the user can make a claim for a reward to those that the user has actually viewed at the host website.

If the date of the lease provided by the user is not earlier than the earliest logged date on which the corresponding listing was transmitted for display to the user (710—no), the host contacts the property owner to verify that a lease was entered into with the user for the unit for which the claim was made with the date specified by the user (712). The property owner is provided a specified amount of time to respond. If the property owner responds negatively within the specified amount of time (714—negative response), the claim is considered invalid (716). Exemplary negative responses may include: that no lease was entered into, that the lease was entered into at a date that is earlier than when the listing was transmitted for display to the user, that the date the lease was entered into is different from the date provided by the user, or that the lease corresponds to a different listing than the one for which the user is making the claim. It should be appreciated, however, that the negative responses given above are non-exhaustive and are merely exemplary. The user is then informed that the claim is invalid (717). In some embodiments, the user may also be informed of the reason for the invalidation of the claim, e.g., the property owner's negative response and the reason for the negative response. The user gets no reward and the property owner is not obligated to pay the corresponding referral fee.

If the property owner responds positively (i.e., the property owner confirms that the lease was entered into at the date specified by the user, which is a date later than the earliest logged date on which the corresponding listing was transmitted for display to the user) within the specified time (714—positive response), the user's claim is validated (718). That is, the user's claim is validated because the lease was entered into on a date that is later than the earliest logged date on which the corresponding listing was transmitted for display to the user. In some embodiments, the claim is validated if, instead, the lease was entered into no earlier than the earliest date the corresponding listing was transmitted for display to the user within a specified time period. The user is informed that the claim is valid (720). The host invoices the property owner for the referral fee (722). The property owner pays the referral fee (724). Provision of the corresponding reward to the user is facilitated (726). In some embodiments, the facilitation includes sending the user instructions for redeeming the reward. For example, if the reward is a monetary payment, the host may send an email or regular mail to the user that includes instructions for getting the payment, e.g. by electronic funds transfer. As another example, if the reward is a coupon or a gift certificate for an online store, the host may send the user an email with the code or link for redeeming the coupon or gift certificate. In some other embodiments, the facilitation includes alerting an employee, representative, or agent of the host (e.g., by displaying to the employee, representative, or agent an alert) that the claim has been validated and instructing the employee, representative, agent, or contractor of the host to initiate a process of getting the corresponding reward to the user.

In some embodiments, it may be inconvenient to invoice the property owner each time a claim is validated. In these embodiments, the property owner may be invoiced at predefined intervals for all claims validated during an invoicing interval. For example, the property owner may be invoiced monthly.

If the property owner fails to respond within the specified time (714—no response), the host proceeds with invoicing the property owner for the referral fee for the claim (728). If the property owner contests the claim (730—yes), then the claim is considered to be invalid (716) and the user is informed that the claim is invalid (717). In some embodiments, the host takes the property owner at his word regarding the contesting of the claim and invalidates the claim without further verification. In some other embodiments, the host may engage in further verification procedures if the claim is contested, and may validate the claim despite the property owner's contesting of the claim. Furthermore, in some embodiments, statistics regarding contesting of claims may be kept by the host in order to monitor potentially excessive contesting of claims by property owners. If the property owner does not contest the invoice (730—no), the claim is validated (718) and the user is informed that the claim is validated (720). The property owner pays the referral fee (724). It should be appreciated that in this case, block 722 may be skipped because the property owner has already been invoiced for the referral fee in block 728. Provision of the corresponding reward to the user is facilitated, as described above (726).

In some embodiments, the property owner contests a claim in an invoice by actively notifying the host, within a specified amount of time, of his refusal to pay the referral fee for that claim. If the property owner pays the referral fee for the claim or does nothing with respect to that claim within the specified amount of time, then the claim is not considered to be contested.

The foregoing description, for purpose of explanation, has been described with reference to specific embodiments. However, the illustrative discussions above are not intended to be exhaustive or to limit the invention to the precise forms disclosed. Many modifications and variations are possible in view of the above teachings. The embodiments were chosen and described in order to best explain the principles of the invention and its practical applications, to thereby enable others skilled in the art to best utilize the invention and various embodiments with various modifications as are suited to the particular use contemplated.

What is claimed is:

1. A method of validating a claim for a reward, comprising:
identifying at a host computer a user associated with a client computer;
transmitting from the host computer to the client computer one or more listings for display to the user;
for each of the one or more listings transmitted, logging at the host computer the respective listing and a date the respective listing was transmitted for display to the user;
receiving a claim that the user has entered into a transaction corresponding to a particular listing of the listings logged at the host computer;
validating the claim if the particular listing was transmitted for display to the user prior to the user entering into the transaction; and
based on the validating, facilitating provision of a reward to the user.

2. The method of claim 1, further comprising invoicing a provider of the particular listing for a referral fee.

3. The method of claim 1, wherein the reward comprises a monetary reward.

4. The method of claim 1, wherein the reward comprises an in-kind reward.

5. The method of claim 1, wherein the facilitating comprises sending to the user instructions for redeeming the reward.

6. The method of claim 1, wherein the one or more listings comprise one or more listings of real estate for lease.

7. The method of claim 1, wherein the one or more listings comprise one or more listings of real estate for sale.

8. The method of claim 1, wherein the one or more listings comprise one or more listings of goods for sale.

9. The method of claim 1, wherein the one or more listings comprise one or more listings of services for sale.

10. The method of claim 1, wherein the logging further comprises logging a time the respective listing was transmitted for display to the user.

11. The method of claim 1, wherein the logging comprises logging an identifier of the respective listing.

12. A method of validating a claim for a reward, comprising:
identifying at a host computer a user associated with a client computer;
transmitting from the host computer to the client computer one or more listings of real estate rental units for display to the user;
for each of the one or more listings transmitted, logging at the host computer the respective listing and a date the respective listing was transmitted for display to the user;
receiving a claim that the user has entered into a lease for a respective real estate rental unit corresponding to a particular listing of the listings logged at the host computer;
validating the claim if the particular listing was transmitted for display to the user prior to the user entering into the lease; and
based on the validating, facilitating provision of a reward to the user.

13. The method of claim 12, further comprising invoicing a provider of the particular listing for a referral fee.

14. The method of claim 12, wherein the reward comprises a discount on a rent for the lease.

15. A system for validating a claim for a reward, comprising:
one or more processors; and
memory coupled to the one or more processors, the memory comprising:
instructions to identify at a host computer a user associated with a client computer;
instructions to transmit from the host computer to the client computer one or more listings for display to the user;
instructions to log at the host computer, for each of the one or more listings transmitted, the respective listing and a date the respective listing was transmitted for display to the user;
instructions to receive a claim that the user has entered into a transaction corresponding to a particular listing of the listings logged at the host computer;
instructions to validate the claim if the particular listing was transmitted for display to the user prior to the user entering into the transaction; and
instructions to facilitate provision of a reward to the user based on the validating.

16. A system, comprising:
one or more processors; and
memory coupled to the one or more processors, the memory comprising:
instructions to identify at a host computer a user associated with a client computer;
instructions to transmit from the host computer to the client computer one or more listings of real estate rental units for display to the user;
instructions to log at the host computer, for each of the one or more listings transmitted, the respective listing and a date the respective listing was transmitted for display to the user;
instructions to receive a claim that the user has entered into a lease for a respective real estate rental unit corresponding to a particular listing of the listings logged at the host computer;
instructions to validate the claim if the particular listing was transmitted for display to the user prior to the user entering into the lease; and
instructions to facilitate provision of a reward to the user based on the validating.

17. A computer program product for use in conjunction with a computer system, the computer program product comprising a computer readable storage medium and a computer program mechanism embedded therein, the computer program mechanism comprising instructions for:
identifying at a host computer a user associated with a client computer;
transmitting from the host computer to the client computer one or more listings for display to the user;
for each of the one or more listings transmitted, logging at the host computer the respective listing and a date the respective listing was transmitted for display to the user;
receiving a claim that the user has entered into a transaction corresponding to a particular listing of the listings logged at the host computer;
validating the claim if the particular listing was transmitted for display to the user prior to the user entering into the transaction; and
based on the validating, facilitating provision of a reward to the user.

18. A computer program product for use in conjunction with a computer system, the computer program product comprising a computer readable storage medium and a computer program mechanism embedded therein, the computer program mechanism comprising instructions for:
identifying at a host computer a user associated with a client computer;
transmitting from the host computer to the client computer one or more listings of real estate rental units for display to the user;
for each of the one or more listings transmitted, logging at the host computer the respective listing and a date the respective listing was transmitted for display to the user;
receiving a claim that the user has entered into a lease for a respective real estate rental unit corresponding to a particular listing of the listings logged at the host computer;
validating the claim if the particular listing was transmitted for display to the user prior to the user entering into the lease; and
based on the validating, facilitating provision of a reward to the user.
